(19) United States
(12) Patent Application Publication
(10) Pub. No.: US 2013/0151120 A1
(43) Pub. Date: Jun. 13, 2013

(54) METHOD OF LEARNING ETHANOL CONCENTRATION FOR FUEL FLEXIBLE VEHICLE

(71) Applicant: Jin Woo Kim, Gunpo-si (KR)

(72) Inventor: Jin Woo Kim, Gunpo-si (KR)

(73) Assignee: Hyundai Motor Company, Seoul (KR)

(21) Appl. No.: 13/534,944

(22) Filed: Jun. 27, 2012

(30) Foreign Application Priority Data
Dec. 9, 2011 (KR) 10-2011-0131835

(51) Int. Cl. F02D 19/08; G01M 15/05; F02D 41/26

(52) U.S. Cl. 701/104; 701/99

(57) ABSTRACT

A method of learning an ethanol concentration for an a fuel flexible vehicle (FFV) enables an ethanol concentration to be learned even when an oxygen sensor of FFV that is not equipped with an ethanol sensor is malfunctioning, thereby suppressing the occurrence of trouble and stalling of an engine and allowing the stable operation of the engine. Accordingly, the method improves the reliability of vehicles and increases the merchantable quality of vehicles.

### CROSS-REFERENCE TO RELATED APPLICATIONS

The present application claims priority of Korean Patent Application Number 10-2011-0131835 filed on Dec. 9, 2011, the entire contents of which application is incorporated herein for all purposes by this reference.

### BACKGROUND OF INVENTION

1. Field of Invention

The present invention relates, in general, to a method of learning an ethanol concentration for a Fuel Flexible Vehicle (FFV), and more particularly, to a technique which ensures the stable operation of a vehicle by correctly estimating an ethanol concentration even when an oxygen sensor malfunctions in a vehicle that has not been equipped with an ethanol sensor.

2. Description of Related Art

With the sharp increase in oil prices, there is a sharp increase in the demand for ethanol fuel which is relatively inexpensive compared to gasoline, especially in Brazil, China, East Asia, the United States, and other places. Moreover, research and development into technology related to FFVs which are capable of using ethanol fuel has been ongoing.

The stoichiometric air-fuel ratio of ethanol used in FFVs is 9:1, which means that relative to gasoline a far greater amount of ethanol is required to obtain the same amount of energy. In vehicles, an ethanol concentration in fuel should be learned so that a fuel quantity could be corrected in accordance with the ethanol concentration. In this way, an engine can smoothly run on any fuel, that is, any mixture of gasoline and ethanol, from pure gasoline up to 100% ethanol.

Accordingly, in order to ensure the starting and stable operation of the engine in an FFV, it is very important to determine the ethanol concentration. However, adding an ethanol sensor to a vehicle increases the cost, so a method of estimating an ethanol concentration without using an ethanol sensor is in demand. One such method is to use an oxygen sensor mounted in front of a catalytic converter.

That is, with use of the oxygen sensor mounted in front of the catalytic converter, a fuel-air ratio of a gas mixture which is to be combusted in a combustion chamber is adjusted by feedback control so as to satisfy the condition of an excessive air ratio λ being equal to 1 (λ=1). In this way, the amount of fuel is learned in a feedback manner, so that the concentration of ethanol in fuel supplied to the combustion chamber is estimated based on the value of the amount of fuel that has been already learned.

However, the above-described oxygen sensor is sometimes likely to fail. In such a case, it is difficult to learn the correct ethanol concentration, which impairs the operating performance of the engine. FIG. 1 illustrates such a situation.

That is, FIG. 1 illustrates a change in the roughness of an engine in the case where an engine first runs on fuel containing 22% ethanol which is refueled in a vehicle, after which it then runs on fuel which is 100% ethanol refueled in the vehicle under the assumption that an oxygen sensor malfunctions and thus the signal from the oxygen sensor is invalid. It can be seen from the figure that the roughness of the engine increases with time. If this roughness becomes extremely severe, the engine may stall.

When any kind of failure occurs in the oxygen sensor, an engine checking lamp flashes to prompt repairs. However, in order to transport a vehicle to a repair shop, the concentration of ethanol in the fuel must be correctly learned so that the engine of the vehicle can continue to operate on the way to the repair shop even with a malfunctioning oxygen sensor.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention provide for a method of learning the ethanol concentration for an FFV.

Various aspects of the present invention provide for a method of learning the ethanol concentration for an FFV. This method enables an ethanol concentration to be learned when an oxygen sensor malfunctions in an FFV that is not equipped with an ethanol sensor, thereby suppressing trouble with an engine and the engine stalling, thereby ensuring the stable operation of the engine. As a result, the reliability of a vehicle improves and the merchantable quality of the vehicle increases.

According to various aspects of the present invention, there is provided a method of learning an ethanol concentration for an FFV including: checking on a sensor to determine whether an oxygen sensor is malfunctioning; determining whether the roughness of an engine is greater than a roughness reference value which is a predetermined value when the checking reveals that the oxygen sensor is malfunctioning; and monitoring, when the determining reveals that the roughness of the engine is greater than the roughness reference value, the roughness of the engine to check whether the roughness of the engine drops below the roughness reference value while an ethanol concentration is being changed from a current learned ethanol concentration which is learned before.

According to other aspects of the invention, there is provided a method of learning an ethanol concentration for an FFV including: determining whether a vehicle is being refueled; determining, when it has been determined that the vehicle is being refueled, whether an oxygen sensor is normally functioning; determining whether the roughness of the engine gradually increases and then has exceeded a roughness reference value when it is determined that the oxygen sensor is malfunctioning; changing manually a current learned ethanol concentration that has been already determined when it is determined that the roughness of the engine has increased and has exceeded the roughness reference value; and determining whether the roughness of the engine has dropped to a value equal to or less than the roughness reference value after the ethanol concentration has been manually changed.

Even when an oxygen sensor in an FFV that is not equipped with an ethanol sensor malfunctions, the present invention makes it possible to learn an ethanol concentration, thereby suppressing the occurrence of trouble and the stalling of the engine and maintaining stable operation of the engine. This improves reliability of a vehicle and hence increases the merchantable quality of the vehicle.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a graphic diagram illustrating a change in the roughness of an engine with time during refueling of fuel for different compositions when an oxygen sensor is malfunctioning;

FIG. 2 is a flowchart illustrating an exemplary method of learning an ethanol concentration for an FFV according to the present invention.

FIG. 3 is a graphic diagram describing an exemplary action of the present invention.

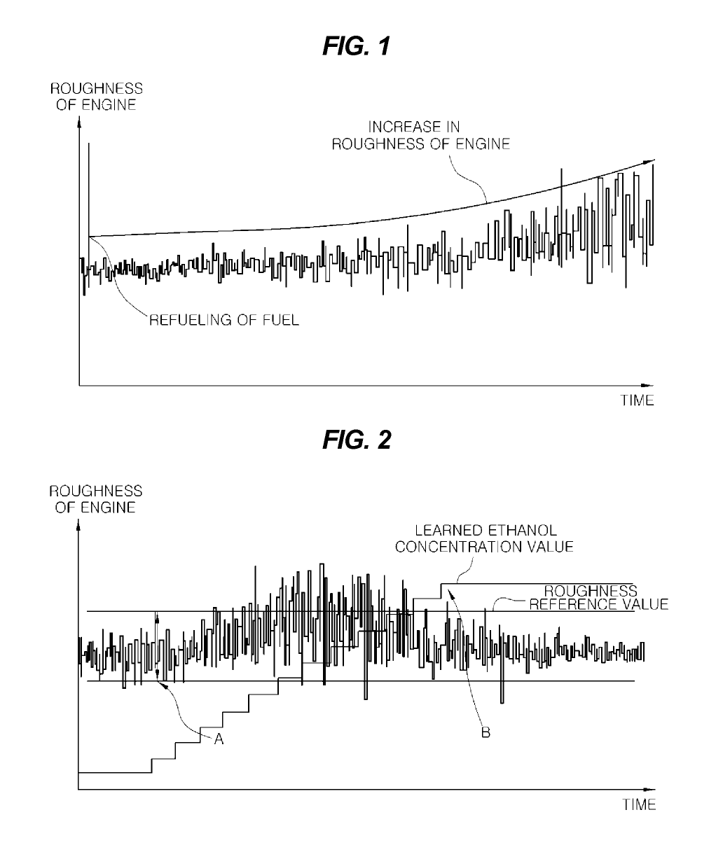

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Referring to FIG. 2, a method of learning an ethanol concentration for a Fuel Flexible Vehicle (FFV) according to an embodiment of the invention includes a sensor check-up step (S20) of determining whether an oxygen sensor is malfunctioning or not, a roughness determining step (S30) of determining whether the roughness of the engine is greater than a predetermined roughness reference value when it has been determined that the oxygen sensor is malfunctioning, and a concentration changing step (S50) of, when it has been determined that the roughness of the engine is greater than the roughness reference value, monitoring the roughness of the engine in order to check whether or not the roughness of the engine drops below the roughness reference value while a current learned ethanol concentration is being changed.

That is, when it is determined that the oxygen sensor is malfunctioning, it is difficult to estimate and learn an ethanol concentration based on a signal output from the oxygen sensor. Accordingly, the ethanol concentration which has already been learned is continuously used to control vehicle driving conditions. However, a difference is likely to occur between this ethanol concentration and an actual concentration of ethanol in the fuel, and as a result the air-to-fuel ratio is improperly set. When this is the case, the roughness of the engine tends to increase. Accordingly, the roughness of the engine is detected and, when it reaches or exceeds a predetermined value, an ethanol concentration which has been currently set is manually changed. In this way, the ethanol concentration is manually changed and the roughness of the engine is continuously monitored. This enables the ethanol concentration to be kept track of.

In the present embodiment, the concentration changing step (S50) includes a concentration determining sub-step (S51) of comparing a current learned ethanol concentration with a predetermined concentration value (concentration reference value), a concentration decreasing sub-step (S52) of monitoring the roughness of the engine to check whether the roughness of the engine drops below the roughness reference value while the ethanol concentration is being gradually decreased when the concentration determining sub-step (S51) has revealed that the current learned ethanol concentration is greater than the concentration reference value, and a concentration increasing sub-step (S53) of monitoring the roughness of the engine to check whether the roughness of the engine has dropped below the roughness reference value while the ethanol concentration is being gradually increased when it is determined that the current learned ethanol concentration is equal to or less than the concentration reference value.

That is, when manually changing the ethanol concentration, if the current learned ethanol concentration is less than the predetermined concentration reference value, an increase in the roughness of the engine is highly likely to be attributable to the fact that an actual ethanol concentration is greater than the learned ethanol concentration. Accordingly, in the concentration increasing sub-step (S53), the value of the ethanol concentration for control is increased. Conversely, if the current learned ethanol concentration is greater than the predetermined concentration reference value, the generation of the roughness of the engine is highly likely to be attributable to the fact that the actual ethanol concentration is relatively less than the current learned ethanol concentration. Accordingly, the value of the ethanol concentration is decreased in the concentration decreasing sub-step (S52). In this way, the actual ethanol concentration is tracked.

The method according to this embodiment may include a refueling determining step (S10) of determining whether or not a vehicle is being refueled and this step may be performed before the roughness determining step (S30) so that the roughness determining step (S30) may be performed only when it is determined that the vehicle is being refueled.

That is, as described above, when the ethanol concentration changes by a lot while the engine is running, there is a high likelihood that the vehicle is being refueled. Accordingly, it is sufficiently effective to execute the control of the present invention only in such a situation.

When the refueling determining step (S10) determines that the vehicle is not being refueled, or when the sensor checking-up step (S20) determines that the oxygen sensor is normally functioning or when the roughness determining step (S30) determines that the roughness of the engine is equal to or less than the roughness reference value, a current learned value of the ethanol concentration is maintained and the control ends.

When the roughness of the engine drops below the roughness reference value after performing the concentration changing step (S50), the ethanol concentration is set to the current concentration value and then the learning the ethanol concentration is terminated. This step is referred to as a concentration learning termination step (S60).

In the roughness determining step (S30), the concentration changing step (S50) may be performed when it is determined that the roughness of the engine has gradually increased and finally exceeded the roughness reference value. That is, while a vehicle is moving, an amount of the engine roughness which is not associated with the actual ethanol concentration, for example an amount of the engine roughness due to knocking, may be generated in an amount greater than the roughness reference value. In order to exclude such a case from situations to be controlled according to the present invention, the present invention may apply to only a case where the roughness of the engine continues to gradually increase with changes in ethanol concentration and finally reaches or exceeds the roughness reference value.

As a reference, the predetermined concentration reference value to be compared with the current learned ethanol concentration may be set to a value within a range of 70% ±10%. If the concentration reference value is excessively high or low, usually it may take a very long time to track the actual ethanol concentration or it is very difficult to track the actual concentration, except for some special cases.

Moreover, the roughness reference value which is to be compared with the actual roughness of the engine is a value determined on an experimental basis. The roughness reference value is set to an appropriate value such that it is difficult for the roughness of the engine to exceed the roughness reference value during normal operation of the engine but it may reach or exceed the roughness reference value right before the engine experiences extreme/severe roughness so that an appropriate ethanol concentration can be learned before the engine stalls.

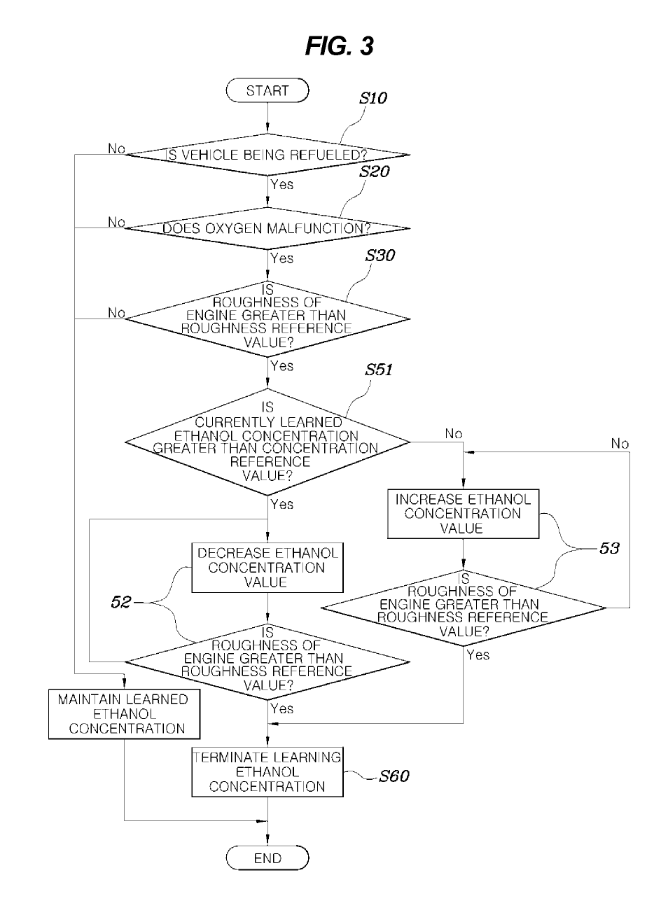

FIG. 3 is a diagram describing the action of the present embodiment described above and illustrates the following states: the roughness of an engine starts to increase at position A, and then exceeds the roughness reference value a given time thereafter, at which point in time the ethanol concentration is manually increased, and as a result the roughness of the engine recovers back to a value within a range of the roughness reference value; thereafter starting from point B, the learned value of the ethanol concentration is maintained.

For convenience in explanation and accurate definition in the appended claims, the terms upper or lower, front or rear, inside or outside, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings The exemplary embodiments were chosen and described in order to explain certain principles of the invention and their practical application, to thereby enable others skilled in the art to make and utilize various exemplary embodiments of the present invention, as well as various alternatives and modifications thereof It is intended that the scope of the invention be defined by the Claims appended hereto and their equivalents.

What is claimed is:

1. A method of learning an ethanol concentration for an FFV comprising:
determining whether or not an oxygen sensor is malfunctioning;
determining whether a roughness of an engine is greater than a roughness reference value that is a predetermined value when it has been determined that the oxygen sensor is malfunctioning; and
monitoring the roughness of the engine, when the determining whether the roughness of an engine is greater than the roughness reference value has revealed that the roughness of the engine is greater than the roughness reference value, in order to check whether the roughness of the engine drops below the roughness reference value while an ethanol concentration is being changed from a current learned ethanol concentration.

2. The method of learning an ethanol concentration for an FFV according to claim 1, wherein the monitoring of the roughness of the engine comprises:
comparing the current learned ethanol concentration with a concentration reference value which is a predetermined value;
first monitoring the roughness of the engine, when the comparing the current learned ethanol concentration with the concentration reference value reveals that the current learned ethanol concentration is greater than the concentration reference value, in order to check whether the roughness of the engine has dropped below the roughness reference value while gradually decreasing an ethanol concentration; and
second monitoring, when the comparing the current learned ethanol concentration with the concentration reference value reveals that the current learned ethanol concentration is equal to or less than the concentration reference value, the roughness of the engine in order to check whether the roughness of the engine has dropped below the roughness reference value while gradually increasing the ethanol concentration.

3. The method of learning an ethanol concentration for an FFV according to claim 1, further comprising:
determining whether the vehicle is being refueled before carrying out the determining whether roughness of an engine is greater than the roughness reference value so that the determining of whether the roughness of the engine is greater than the roughness reference value is made only when it has been determined that the vehicle is being refueled.

4. The method of learning an ethanol concentration for an FFV according to claim 3, wherein the current learned ethanol concentration is maintained constant and a control is terminated when the determining of refueling has determined that the vehicle is being refueled, or when the determining of malfunctioning of the oxygen sensor has determined that the oxygen sensor is functioning normally, or when the determining of whether roughness of an engine is greater than the roughness reference value has revealed that the roughness of the engine is equal to or less than the roughness reference value.

5. The method of learning an ethanol concentration for an FFV according to claim 1, further comprising:
setting the ethanol concentration to a current concentration value and terminating learning of the ethanol concentration when the roughness of the engine has dropped below the roughness reference value after the monitoring of the roughness of the engine has been performed.

6. The method of learning an ethanol concentration for an FFV according to claim 1, wherein the monitoring of the roughness of the engine is performed when the roughness of the engine gradually increases up to a value greater than the roughness reference value when carrying out the determining of whether the roughness of an engine is greater than the roughness reference value.

7. A method of learning an ethanol concentration for an FFV, comprising:
determining whether a vehicle is being refueled;
determining whether an oxygen sensor is normally functioning when it has been determined that the vehicle is being refueled;
determining whether a roughness of an engine gradually increases up to a value greater than a roughness reference value that is a predetermined value when it has been determined that the oxygen sensor is malfunctioning;
changing gradually a current learned ethanol concentration when the roughness of the engine has reached to a value greater than the roughness reference value; and
determining whether the roughness of the engine drops below the roughness reference value while manually changing an ethanol concentration.

8. The method of learning an ethanol concentration for an FFV according to claim 7, wherein in the determining of whether the roughness of the engine has dropped below the roughness reference value, the ethanol concentration is gradually decreased when the current learned ethanol concentration is greater than a concentration reference value that is a predetermined value and is gradually increased when the current learned ethanol concentration is equal to or less than the concentration reference value.

9. The method of learning an ethanol concentration for an FFV according to claim 8, wherein the predetermined concentration reference value is set to a value within a range of 70% ±10%

10. The method of learning an ethanol concentration for an FFV according to claim 7, further comprising:
maintaining the current learned ethanol concentration constant and terminating control when it has been determined that the vehicle is not being refueled or when it has been determined that the roughness of the engine is equal to or less than the roughness reference value; and
maintaining a final ethanol concentration which is obtained by manually changing the ethanol concentration and terminating learning the ethanol concentration when it is determined that the roughness of the engine has dropped below the roughness reference value after the ethanol concentration has been manually changed.
